(19) United States
(12) Patent Application Publication
(10) Pub. No.: US 2025/0390981 A1
(43) Pub. Date: Dec. 25, 2025

(54) MEDIA PROCESSING METHOD, DEVICE, APPARATUS, AND MEDIUM

(71) Applicant: Beijing Zitiao Network Technology Co., Ltd., Haidian District (CN)

(72) Inventors: Dingding XU, Beijing (CN); Meng YAN, Beijing (CN)

(21) Appl. No.: 19/243,352

(22) Filed: Jun. 19, 2025

(30) Foreign Application Priority Data
Jun. 19, 2024 (CN) 202410797381.4

(51) Int. Cl. G06T 3/18; G06T 3/40; G06T 5/70; G06T 15/00

(52) U.S. Cl. CPC G06T 3/18; G06T 3/40; G06T 5/70; G06T 15/00; G06T 2207/10024

(57) ABSTRACT

The present disclosure provides a media processing method, a device, an apparatus, and a medium, a specific embodiment of the method includes: obtaining a base image, and determining luminance of a pixel in the base image; determining visual stretching information based on the luminance of the pixel, wherein the visual stretching information includes stretching amount of the pixel at a plurality of different time points, and at a same time point, stretching amount of the pixel is associated with the luminance of the pixel; and based on the visual stretching information and the base image, obtaining a plurality of frames of target images for generating dynamic media.

### CROSS-REFERENCE TO RELATED APPLICATION(S)

The present application claims the priority of Chinese Patent Application No. 202410797381.4, filed on Jun. 19, 2024, and the disclosure of the above-mentioned Chinese Patent Application is incorporated herein by reference as a part of the present application.

### TECHNICAL FIELD

The present disclosure relates to the field of media processing technologies, and in particular, to a media processing method, a device, an apparatus, and a medium.

### BACKGROUND

With the continuous development and improvement of digital media technologies such as video, image, and animation, digital media has been applied to more and more extensive fields. For example, digital media is widely used in fields such as advertising, film, art, and new media. The media not only brings a lot of convenience to people, but also adds more fun to people's lives. In order to vitalize the media, people usually use technical means to add special effects on the existing media to obtain more vivid and expressive media. At present, it is desirable for a media processing scheme that processes an existing two-dimensional static image into a three-dimensional dynamic image.

### SUMMARY

The present disclosure provides a media processing method, a device, an apparatus, and a medium.

According to a first aspect, a method for processing media is provided, and the method includes:
obtaining a base image, and determining luminance of a pixel in the base image;
determining visual stretching information based on the luminance of the pixel, wherein the visual stretching information includes stretching amount of the pixel at a plurality of different time points, and at a same time point, stretching amount of the pixel is associated with the luminance of the pixel; and
based on the visual stretching information and the base image, obtaining a plurality of frames of target images for generating dynamic media.

According to a second aspect, a device for processing media is provided, and the device includes:
an obtaining module, configured to obtain a base image and determine luminance of a pixel in the base image;
a determining module, configured to determine visual stretching information based on the luminance of the pixel, wherein the visual stretching information includes stretching amount of the pixel at a plurality of different time points, and at a same time point, stretching amount of the pixel is associated with the luminance of the pixel; and
a generation module, configured to, based on the visual stretching information and the base image, obtain a plurality of frames of target images for generating dynamic media.

According to a third aspect, a computer-readable storage medium is provided, the storage medium has a computer program stored thereon, wherein the computer program, when executed by a processor, implements the method according to any one of the first aspect.

According to a fourth aspect, provided is an electronic apparatus, including a memory and a processor, and a computer program stored on the memory and can be executed by the processor, wherein the processor, when executing the program, implements the method according to any one of the first aspect.

It should be understood that the above general description and the detailed description

below are only illustrative and explanatory and do not limit the present disclosure.

### BRIEF DESCRIPTION OF DRAWINGS

In order to more clearly illustrate the technical solutions in the embodiments of the present disclosure, the following provides a brief introduction to the drawings to be used in the description of the embodiments. It is apparent that the drawings described below illustrate some embodiments described herein, and those skilled in the art may obtain other drawings according to these drawings without creative labor.

FIG. 1 is a schematic diagram of a media processing scene illustrated according to an exemplary embodiment of the present disclosure;

FIG. 2 is a flow chart of a media processing method illustrated according to an exemplary embodiment of the present disclosure;

FIG. 3 is a flow chart of another media processing method illustrated according to an exemplary embodiment of the present disclosure;

FIG. 4 is a schematic diagram of a scene illustrated according to an exemplary embodiment of the present disclosure;

FIG. 5 is a block diagram of a media processing device illustrated according to an exemplary embodiment of the present disclosure; and

FIG. 6 is a schematic block diagram of another electronic apparatus provided in some embodiments of the present disclosure.

### DETAILED DESCRIPTION

In order to make persons skilled in the art better understand the technical solutions of the present disclosure, the technical solutions in the embodiments of the present disclosure will be clearly and completely described below in conjunction with the accompanying drawings in the embodiments of the present disclosure, it is obvious that the described embodiments are only a part of the embodiments of the present disclosure, rather than all of the embodiments. Based on the embodiments of the specification, all other embodiments obtained by those skilled in the art without making creative labor belong to the scope of protection of the present disclosure.

The following description is made with reference to drawings, where similar numerals in the drawings represent similar or same elements, unless otherwise indicated. The embodiments described in the following exemplary embodiments do not represent all embodiments consistent with the present disclosure. Instead, they are only examples of device and methods that are consistent with some aspects of the present disclosure, as detailed in the attached claims.

The terms used in the present disclosure are intended solely to describe specific embodiments and are not intended to limit the present disclosure. The singular forms “a” and “the” as used herein are also intended to include the plurality forms, unless expressly indicated otherwise in the context. It should also be understood that the term “and/or” as used herein refers to and encompasses any or all possible combinations of one or more associated listed items.

It should be understood that, although the terms “first”, “second”, “third”, and the like may be used herein to describe various types of information, such information should not be limited to these terms. These terms are only used to distinguish same types of information from each other. For example, first information may also be referred to as second information without departing from the scope of the present disclosure, and similarly, the second information may also be referred to as the first information. Depending on the context, the word “if” as used herein may be interpreted as “when . . . ” or “in the case that . . . or “in response to confirming . . . ”.

With the continuous development and improvement of digital media technologies such as video, image, and animation, digital media has been applied to more and more extensive fields. For example, digital media is widely used in fields such as advertising, film, art, and new media. The media not only brings a lot of convenience to people, but also adds more fun to people's lives. In order to make the media more vivid, people usually use technical means to add special effects on the existing media to obtain more vivid and expressive media.

For example, an existing two-dimensional static image may be processed into a three-dimensional dynamic image to obtain more vivid special effect media. In related technologies, it is usually necessary for people to manually create multiple frames of associated images based on an existing image, and then generate a dynamic video or an animated image based on the existing image and the multiple frames of associated images. Therefore, due to the limitation of the professional level of the person that carrying out such processing, it requires high competency for producing the above-mentioned special effect media, with a low efficiency, making it difficult to efficiently produce a high-quality special effect media work. In addition, the effect of the resulted special effect media is also not satisfactory with regard to the people's needs, making it difficult to promote the production of the above-mentioned special effect media among common people.

A method and an device for processing media provided in the embodiments of the present disclosure determine luminance of pixels in a base image by acquiring the base image; determine visual stretching information based on the luminance of the pixels in the base image, where the visual stretching information may include a plurality of stretching amount of the pixels at several time points, and at a same time point, the stretching amount of the pixel is associated with the luminance of the pixel; and obtain a plurality of frames of target images for generating dynamic media according to the visual stretching information and the base image. In this way, the dynamic media with pixel dynamic stretching special effect may be generated according to the static image, such that the dynamic media has a higher picture quality and a more realistic special effect, and user experience is improved.

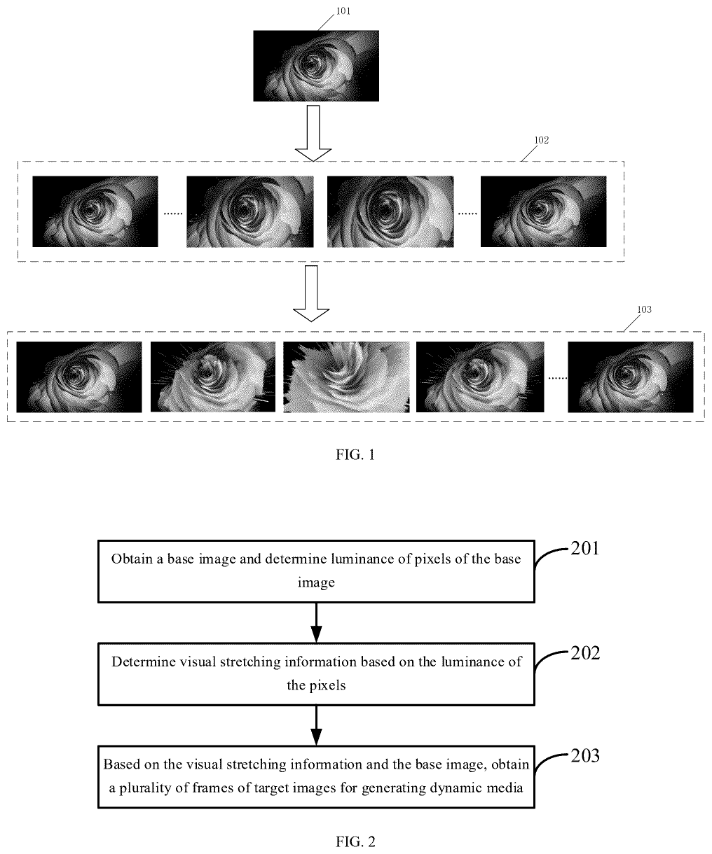

Referring to FIG. 1, a schematic diagram of a media processing scene is illustrated according to an exemplary embodiment of the present disclosure.

As shown in FIG. 1, firstly, a frame of an original image 101 is obtained, and the original image 101 may be gradually scaled according to a plurality of scaling ratios that are gradient respectively, so as to obtain a plurality of base image frames 102. Then, the luminance of the pixels in each frame of the base image 102 is obtained, and the target image 103 with a pixel stretching special effect is generated according to the luminance of the pixels in the base image 102. One frame of target image may be generated, or a plurality of frames of target images may be generated according to one frame of the base image 102.

Specifically, since multiple frames of target images are used to generate the dynamic media (for example, a video, or the like), each frame of target image may correspond to a playback time point. Moreover, each frame of target image is an image with a stretching special effect of pixels in the base image corresponding to the frame of target image at a playback time point. Therefore, for each playback time point, each pixel corresponds to stretching amount. At a same playback time point, stretching amount of a pixel is associated with the luminance of the pixel. The stretching amount of the pixels at each playback time point may be determined according to the luminance of the pixels in the multiple frames of the base image 102, and then the target image corresponding to each playback time point is generated according to the stretching amount of the pixels at each playback time point.

The present disclosure is described in detail below with reference to specific embodiments.

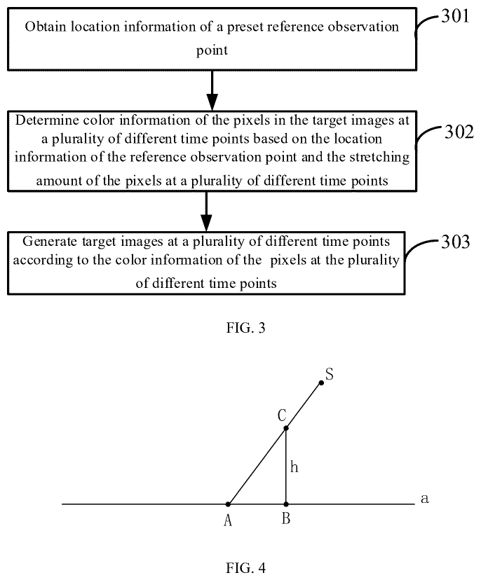

FIG. 2 is a flow chart of a media processing method illustrated according to an exemplary embodiment. The method may be applied to a terminal apparatus. In the present embodiment, to facilitate understanding, a terminal apparatus capable of installing a media processing application is used for illustration as an example. Those skilled in the art may understand that the terminal apparatus may include, but is not limited to, a mobile terminal apparatus such as a smart phone, a smart wearable apparatus, a tablet, a laptop, a desktop computer, or the like. The method may include the following steps:

As shown in FIG. 2, in step 201, a base image is acquired, and the luminance of pixels in the base image is determined.

In the present embodiment, the base image may be an image for stretching processing of the pixels. In an implementation, one frame of an original image may be directly used as the base image, and then multiple frames of target images may be respectively generated based on one frame of the base image. In another implementation, the pixels of the original image may be translated up or down or to the left or right to obtain multiple base image frames. Then, based on each frame of the base image, one or more frames of target images are generated.

In another implementation, after obtaining a frame of the original image, the original image may be scaled respectively according to multiple scaling ratios that are gradient to obtain multiple base image frames. Thereafter, one frame of target image may be generated, or a plurality of frames of target images may be generated according to each base image frame. For example, N frames of target images may be generated based on each base image frame, and in response to that there are M base image frames, then N*M frames of target images may be generated.

Among them, scaling may be performed according to multiple scaling ratios that are gradient. For example, it may be gradually scaled up from an original size and then gradually scaled down back to the original size, or it may gradually be scaled up from the original size, then gradually scaled down back to the original size, and then may gradually scaled down from the original size, or the like. It may be understood that the present embodiment is not limited to the specific settings of the plurality of scaling ratios that are gradient. For example, when the image is first scaled up from the original size and then gradually scaled down back to the original size, the multiple scaling ratios that are gradient may include 1 times, 1.01 times, 1.02 times, 1.03 times, 1.04 times, 1.05 times, 1.04 times, 1.03 times, 1.02 times, 1.01 times, and 1 times. After obtaining a frame of the original image, the original image may be scaled respectively according to the above multiple scaling ratios that are gradient to obtain 11 base image frames. The target image is then generated based on the 11 base image frames, and the number of frames of the target image may be greater than 11 or equal to 11.

In the present embodiment, because multiple scaling ratios that are gradient are used to scale the original image to obtain a plurality of base image frames, such that the target image for generating dynamic media is obtained based on the base image, thereby improving dynamic stretching special effect of pixels in the dynamic media and further improving user experience.

In the present embodiment, after acquiring at least one base image frame, the luminance of each pixel in each base image frame may be determined. For example, a preset algorithm may be used to calculate the luminance of each pixel based on the pixel value of each pixel in each base image frame. It may be understood that the specific means for determining the luminance of pixels is not limited in the present embodiment.

In step 202, based on the luminance of the pixels, visual stretching information is determined.

In the present embodiment, the visual stretching information may include a plurality of stretching amount of pixels at different time points, and at a same time point, stretching amount of the pixel is associated with the luminance of the pixel. For example, the stretching amount of the pixel is positively correlated with the luminance of the pixel. Wherein, the different time points involved in the visual stretching information may correspond to different playback time points in the dynamic media, and the stretching amount of pixel may be a stretching degree of each pixel in the base image presented after adding a stretching special effect. Specifically, since the target image generated based on the base image is an special effect image with the stretching special effect of the pixels of the base image, and each frame of target image corresponds to a time point (that is, a playback time point in the dynamic media), the stretching amount of pixels at each of the different time points may be firstly determined based on the base image, and then the target image corresponding to each of the different time points is generated based on the stretching amount of the pixels at each of the different time points.

In an implementation, stretching coefficients corresponding to a plurality of different time points may be obtained, and the visual stretching information may be determined according to a product of the luminance of each pixel and the stretching coefficient. Wherein, for any one pixel at any one time point, the luminance of the pixel may be multiplied by the stretching coefficient corresponding to the time point, and the product may be used as the stretching amount of the pixel at the time point. The stretching amount of each pixel at each time point may be obtained as the visual stretching information. For example, if the luminance of pixel a is La, and the stretching coefficient corresponding to time point T1 is m1, L=La*m1 may be used as the stretching amount of the pixel a at the time point T1.

Wherein, because the dynamic media needs to present a dynamic stretching special effect, the stretching coefficient is used to constrain the stretching degree of pixels at different time points, such that the pixels have different stretching degrees at the different time points. Optionally, the stretching coefficient corresponding to any time point may be positively correlated with the cosine value of the time difference between the time point and a preset time point. For example, the time difference between any playback time point of the dynamic media and a middle time point of the dynamic media may be multiplied by an empirical constant value, and the cosine value of the resulting product may be used as the stretching coefficient for the playback time point.

Because the present embodiment restricts the stretching degree of the pixels at different time points through the stretching coefficient, the dynamic pixel stretching special effect is enhanced, thereby improving the special effect and the user experience.

In step 203, based on the visual stretching information and the base image mentioned above, multiple frames of target images are obtained for generating the dynamic media.

In the present embodiment, the target image may be an image resulted by adding a stretching special effect to the pixels in the base image according to the stretching amount of the pixels in the base image. Specifically, location information of a preset reference observation point may be obtained, and color information of the pixels at a plurality of time points is determined based on the location information of the reference observation point and the stretching amount of the pixels at a plurality of different time points, and target images corresponding to a plurality of time points are generated according to the color information of the pixels at a plurality of time points.

In the present embodiment, after generating the target images corresponding to a plurality of time points, the different time points may be regarded as video playback time points, and the dynamic media may be generated based on multiple frames of target images. Because the pixels in the target images corresponding to different time points have different stretching special effects, the dynamic media has a dynamic stretching special effect. It should be noted that, the dynamic media may be a video, an animated image, an animation, or the like, and the specific type of the dynamic media is not limited in the present embodiment.

A media processing method provided in the embodiments of the present disclosure determines a luminance of pixels in a base image by acquiring the base image; determines visual stretching information based on the luminance of the pixels in the base image, wherein the visual stretching information may include a plurality of stretching amount of the pixels at a plurality of different time points, and at a same time point, the stretching amount of the pixel is associated with the luminance of the pixel; and obtains a plurality of frames of target images for generating dynamic media according to the visual stretching information and the base image. In this way, the dynamic media with pixel dynamic stretching special effect can be generated according to the static image, such that the dynamic media has a higher picture quality and a more realistic special effect, thereby improving user experience.

FIG. 3 is a flow chart of another media processing method illustrated according to an exemplary embodiment. The embodiment describes a process for obtaining a target image, which includes the following steps:

As shown in FIG. 3, in step 301, location information of a preset reference observation point is obtained, and in step 302, color information of the pixels in the target image at a plurality of different time points is determined based on the location information of the reference observation point and the stretching amount of the pixels at a plurality of different time points.

In the present embodiment, the reference observation point may be a virtual point, and a location of the reference observation point may be an assumed location of a human eye. In other word, assuming that objects in the image are three-dimensional, then the special effect of the image presentation can be seen at the location of the reference observation point. The location of the reference observation point may be preset, and for better presentation, the location of the reference observation point may be set directly above the center of the image. The color information of the pixels in each frame of target image at each of a plurality of different time points is determined based on the location information of the reference observation point and the stretching amount of the pixels at a plurality of different time points.

For any time point, the color information of the pixels in the frame of target image corresponding to the time point may be determined based on the location information of the reference observation point and the stretching amount of the pixels at the time point through the following method. Firstly, color sampling information of the pixels in the target image corresponding to the time point may be determined based on the location information of the reference observation point and the stretching amount of the pixels at the time point. Then, based on the color sampling information, the color information of the pixels in the target image corresponding to the time point is obtained from the base image.

Specifically, the color sampling information of the pixel in the target image may be the location information of a pixel color obtained from the base image. For example, the color sampling information of pixel b in the target image may be coordinate information of pixel c in the base image, and a color value of pixel c may be obtained from the base image based on the coordinate information of pixel c, and may be used as the color information of pixel b in the target image.

In the present embodiment, the color sampling information of any pixel in the target image at the time point may be determined based on the location information of the reference observation point and the stretching amount of the pixel at the time point through the following method. Firstly, based on the location information of the reference observation point, a connecting line from the pixel to the reference observation point may be determined. Then, a target point on the connecting line is determined, such that a difference between a height corresponding to the target point and stretching amount corresponding to the target point is lower than a preset difference. Wherein, the height corresponding to the target point is a height from the target point to an image plane, and the stretching amount corresponding to the target point is the stretching amount of a projected pixel of the target point on the image plane. Finally, the location information corresponding to the projected pixel of the target point on the image plane is used as the color sampling information of the pixel.

For example, as shown in FIG. 4, plane a is an image plane, point S is a reference observation point, and point A is a pixel on the image plane. Point A and point S may be connected, and point C may be found on a straight line AS, and a projection of point C on the image plane is point B, such that the pixel stretching amount corresponding to point B is approximately equal to a height h of point C. Location coordinates of point B may be used as the color sampling information corresponding to point A. In some embodiments, an iterative step method may be used to determine the point C. For example, a step length d may be preset, and point C′ is reached by extending a step length d from the point A along the direction from A to S, and determining whether the pixel stretching amount corresponding to the projection point B′ of point C′ on the image plane satisfies the condition that it is approximately equal to the height of point C′. If not, then further extending forward, by the step length d, from point C′. This process is repeated, until the point C that meets the condition is found. It may be understood that the present embodiment may also determine the color sampling information of the pixel by any other reasonable means, and this aspect is not limited in the present embodiment.

In step 303, a plurality of target images at different time points are generated according to the color information of pixels at a plurality of different time points.

In the present embodiment, a Gaussian blur method may be used to respectively perform a blur rendering operation based on the color information of pixels at a plurality of different time points to obtain a plurality of target images corresponding to the plurality of different time points. Because the blur rendering is used to obtain the target image, the pixel stretching special effect is improved, and jagged burrs at the stretched end of the pixel are avoided.

Furthermore, in an implementation, for any time point, the luminance of the pixels at the time point may first be determined according to the color information of the pixels at the time point. Then, according to the luminance of the pixels at the time point, the blur kernel required for Gaussian blur processing is determined. Because the blur kernel is positively correlated with the luminance of the pixel, the blur kernel is a dynamic blur kernel. Then, according to the color information of the pixels at the time point, the blur kernel is used to carry out a blur rendering operation by using the Gaussian blur method, so as to obtain the target image at the time point. The dynamic blur kernel is used for the blur rendering operation, which may greatly reduce the amount of computation and improve the rendering efficiency.

The present embodiment determines the color information of the pixels based on a preset reference observation point, in combination with the stretching amount of the pixels, thereby providing better and more realistic three-dimensional effect of the dynamic media, and being helpful to improve the user experience.

It should be noted that, although operations of the methods according to the embodiments of the present disclosure are described in a particular order in the above embodiments, this does not require or imply that they must be performed in that particular order, or that all of the operations illustrated must be performed in order to achieve the expected result. Instead, the steps illustrated in the flow chart may be implemented in a different order. Additively or alternatively, certain steps may be omitted, or multiple steps may be combined into a single step, and/or one step may be divided into multiple steps.

Corresponding to the foregoing embodiment of the media processing method, the present disclosure also provides an embodiment of a media processing device.

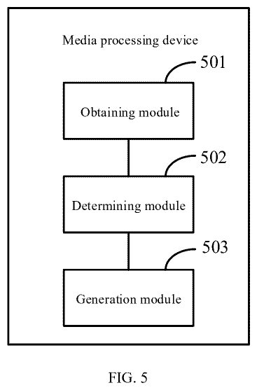

As shown in FIG. 5, FIG. 5 is a block diagram of a media processing device illustrated according to an exemplary embodiment of the present disclosure. The device may include: an obtaining module 501, a determining module 502, and a generation module 503.

Wherein, the obtaining module 501 is configured to obtain a base image and determine a luminance of pixels in the base image.

The determining module 502 is configured to determine visual stretching information based on the luminance of the pixels, wherein the visual stretching information includes stretching amount of the pixels at a plurality of different time points, and at a same time point, the stretching amount of the pixel is associated with the luminance of the pixel.

The generation module 503 is configured to, based on the visual stretching information and the base image, obtain a plurality of frames of target images for generating dynamic media.

In some implementations, the obtaining module 501 is configured to obtain a frame of an original image and perform scaling on the original image respectively according to multiple scaling ratios that are gradient to obtain a plurality of base image frames.

In some other implementations, the determining module 502 is configured to obtain a plurality of stretching coefficients corresponding to different time points, and determine the visual stretching information according to a product of the luminance and the stretching coefficient.

In some other implementations, the stretching coefficient corresponding to any time point is positively correlated with a cosine value of a time difference between the time point and a preset time point.

In some other implementations, the generation module 503 may include: an obtaining submodule, a determining submodule, and a generation submodule (not shown).

Wherein, the obtaining submodule is configured to obtain location information of a preset reference observation point.

The determining submodule is configured to determine color information of the pixels in the target images at a plurality of time points based on the location information of the reference observation point and the stretching amount of the pixels at the plurality of different time points.

The generation submodule is configured to generate target images at a plurality of different time points according to the color information of pixels in target images at the plurality of different time points.

In some other implementations, for any time point, the determining submodule may determine the color information of the pixels in the target image corresponding to the time point based on the location information of the reference observation point and the stretching amount of the pixels at the time point through the following method: determining color sampling information of the pixels in the target image corresponding to the time point based on the location information of the reference observation point and the stretching amount of the pixels at the time point; and based on the color sampling information, obtaining the color information of the pixels in the target image corresponding to the time point from the base image.

In some other implementations, the determining submodule may determine the color sampling information of any pixel in the target image at the time point based on the location information of the reference observation point and the stretching amount of the pixel at the time point through the following method: based on the location information of the reference observation point, determining a connecting line from the pixel to the reference observation point, and determining a target point on the connecting line such that a difference value between a height corresponding to the target point and the stretching amount corresponding to the target point is less than a preset difference value. The height corresponding to the target point is a height from the target point to an image plane, and the stretching amount corresponding to the target point is the stretching amount of a projected pixel of the target point on the image plane. The location information corresponding to the projected pixel of the target point on the image plane is configured as the color sampling information of the pixel.

In some other implementations, the generation submodule is configured to use a Gaussian blur algorithm to perform a blur rendering operation based on the color information of pixels at a plurality of different time points to obtain a plurality of target images corresponding to the plurality of different time points.

For the device embodiment, because it basically corresponds to the method embodiment, the relevant content may be referred to the description of the method embodiment. The device embodiment described above is merely illustrative, where the unit described as a separated part may be or may not be physically separated, and a part displayed as a unit may be or may not be a physical unit, that is, may be located in a place, or may also be distributed in a plurality of network units. Some or all of these modules may be selected according to actual needs to realize the purpose of the embodiments of the present disclosure. Those skilled in the art may understand and implement it without creative effort.

Some embodiments of the present disclosure provide an electronic apparatus. The electronic apparatus includes a processor and a memory and may be used to implement a client or server. The memory is configured to store a computer-executable instruction in a non-transient manner (for example, one or more computer program modules). The processor is configured to execute the computer-executable instruction, wherein the computer-executable instruction, when being executed by the processor, may perform one or more steps in the media processing method described above, so as to implement the media processing method described above. The memory and the processor may be interconnected by a bus system and/or another form of connection mechanism (not shown).

For example, the processor may be a central processing unit (CPU), a graphic processing unit (GPU), or another form of processing unit with a data processing capability and/or a program execution capability. For example, the central processing unit (CPU) may be x86 or ARM architecture, or the like. The processor may be a general-purpose processor or a specialized processor that can control other components in the electronic apparatus to perform the desired functions.

For example, the memory may include any combination of one or more computer program products, which may include various forms of computer-readable storage media, such as a volatile memory and/or a non-volatile memory. The volatile memory may include, for example, a random access memory (RAM) and/or a cache. The non-volatile memory may include, for example, a read-only memory (ROM), a hard disk, an erasable programmable read-only memory (EPROM), a portable compact disk read-only memory (CD-ROM), a USB memory, a flash memory, and the like. One or more computer program modules may be stored on the computer-readable storage medium, and the processor may execute one or more computer program modules to implement various functions of the electronic apparatus. In a computer-readable storage medium, it is also possible to store various applications and various data, as well as various data used and/or generated by applications, or the like.

It should be noted that in the embodiments of the present disclosure, the specific functions and technical effects of the electronic apparatus may be referred to the description above with respect to the media processing method, and are not described again here.

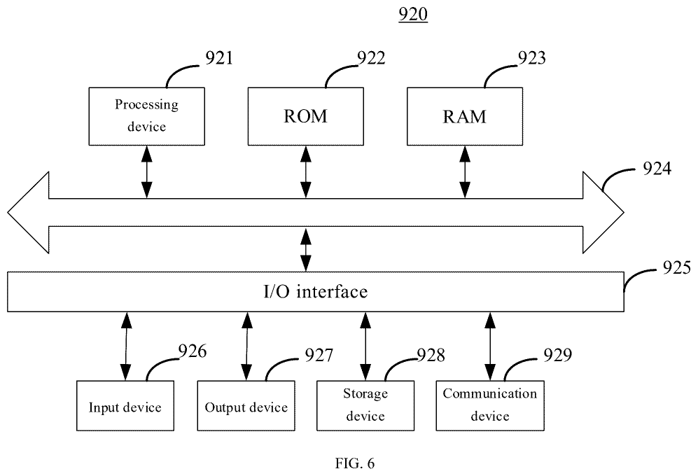

FIG. 6 is a schematic block diagram of an electronic apparatus provided in some embodiments of the present disclosure. The electronic apparatus 920 is, for example, adapted to implement the media processing method provided in the embodiments of the present disclosure. The electronic apparatus 920 may be a terminal apparatus that may be used to implement a client or server. The electronic apparatus 920 may include, but is not limited to, a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, or a fixed terminal such as a digital TV, a desktop computer, a smart home device, or the like. It should be noted that, the electronic apparatus 920 illustrated in FIG. 6 is merely an example, and should not pose any limitation to the functions and the range of use of the embodiments of the present disclosure.

As illustrated in FIG. 6, the electronic apparatus 920 may include a processing device (e.g., a central processor, a graphics processor, etc.) 921, which can perform various suitable actions and processing according to a program stored in a read-only memory (ROM) 922 or a program loaded from a storage device 928 into a random-access memory (RAM) 923. The RAM 923 further stores various programs and data required for operations of the electronic apparatus 920. The processing device 921, the ROM 922, and the RAM 923 are interconnected through a bus 923. An input/output (I/O) interface 925 is also connected to the bus 924.

Usually, the following devices may be connected to the I/O interface 925: an input device 926 including, for example, a touch screen, a touch pad, a keyboard, a mouse, a camera, a microphone, an accelerometer, a gyroscope, or the like; an output device 927 including, for example, a liquid crystal display (LCD), a loudspeaker, a vibrator, or the like; a storage device 928 including, for example, a magnetic tape, a hard disk, or the like; and a communication device 929. The communication device 929 may allow the electronic apparatus 920 to be in wireless or wired communication with other electronic apparatuses to exchange data. While FIG. 6 illustrates the electronic apparatus 920 having various devices, it should be understood that not all of the illustrated devices are necessarily implemented or included. More or fewer devices may be implemented or included in the electronic apparatus 920 alternatively.

For example, according to the embodiments of the present disclosure, the media processing method described above may be implemented as a computer software program. For example, the embodiments of the present disclosure include a computer program product, which includes a computer program carried by a non-transitory computer-readable medium. The computer program includes program codes for performing the foregoing media processing method. In such embodiments, the computer program may be downloaded online through the communication device 929 and installed, or may be installed from the storage device 928, or may be installed from the ROM 922. When the computer program is executed by the processing device 921, the features specified in the media processing method provided in the embodiments of the present disclosure are implemented.

Some embodiments of the present disclosure provide a storage medium. For example, the storage medium may be a non-transient computer-readable storage medium that is configured to store a non-transient computer-executable instruction. The non-transient computer-executable instruction, when being executed by the processor, implements the media processing method described in the embodiments of the present disclosure. For example, the non-transient computer executable instruction, when being executed by a processor, may implement one or more steps in the media processing method described above.

For example, the storage medium may be applied to the electronic apparatus described above. For example, the storage medium may include a memory in the electronic apparatus.

For example, the storage media may include a memory card of a smart phone, a storage component of a tablet, a hard disk of a personal computer, a random-access memory (RAM), a read-only memory (ROM), an erasable programmable read-only memory (EPROM), a portable compact disk read-only memory (CD-ROM), a flash memory, or any combination of the above-mentioned storage medias, or other applicable storage media.

For example, description of the storage medium may be referred to the description of the memory in the embodiment of the electronic apparatus, and repetitions will not be described again. The specific functions and technical effects of the storage medium may be referred to the description above about the media processing method, and will not be described again here.

It should be noted that in the context of the present disclosure, a computer-readable storage medium may be a tangible medium containing or storing a program to be used by, or in combination with, an instruction execution system, an instruction execution device or an instruction execution apparatus. The above-mentioned computer-readable medium may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) or the like, or any appropriate combination of them.

A person skilled in the art may easily obtain other embodiments of the present disclosure after considering the description and practice of the invention disclosed herein. The present disclosure is intended to cover any variants, uses, or adaptations of the present disclosure, which follow the general principles of the present disclosure and include common knowledge or customary technical means in the present technology field that are not disclosed in the present disclosure. The description and embodiments are considered to be illustrative only, and the true scope and spirit of the present disclosure are defined by the claims.

It should be understood that the present disclosure is not limited to the precise structure already described above and shown in the drawings, and may be modified and altered in various ways without departing from the scope thereof. The scope of the present disclosure is only limited by the attached claims.

1. A method for processing media, comprising:
obtaining a base image, and determining luminance of a pixel in the base image;
determining visual stretching information based on the luminance of the pixel, wherein the visual stretching information comprises stretching amount of the pixel at a plurality of different time points, and at a same time point, stretching amount of the pixel is associated with the luminance of the pixel; and
based on the visual stretching information and the base image, obtaining a plurality of frames of target images for generating dynamic media.

2. The method according to claim 1, wherein obtaining the base image comprises:
obtaining a frame of an original image;
performing scaling processing on the original image according to a plurality of scaling ratios that are gradient to obtain a plurality of frames of base images, respectively.

3. The method according to claim 1, wherein determining the visual stretching information based on the luminance of the pixel comprises:
obtaining stretching coefficients respectively corresponding to the plurality of different time points; and
determining the visual stretching information according to products respectively obtained by multiplying the luminance and the stretching coefficients.

4. The method according to claim 3, wherein a stretching coefficient corresponding to a time point of the plurality of different time points is positively correlated with a cosine value of a time difference between the time point and a preset time point.

5. The method according to claim 1, wherein based on the visual stretching information and the base image, obtaining the plurality of frames of target images for generating the dynamic media comprises:
obtaining location information of a reference observation point that is preset;
determining color information of the pixel in the target images at the plurality of different time points based on the location information of the reference observation point and the stretching amount of the pixel at the plurality of different time points; and
generating the target images at the plurality of different time points according to the color information of the pixel in the target images at the plurality of different time points.

6. The method according to claim 5, wherein, for a time point of the plurality of different time points, the color information of the pixel in a target image at the time point is determined based on the location information of the reference observation point and stretching amount of the pixel at the time point through following means:
determining color sampling information of the pixel in the target image at the time point based on the location information of the reference observation point and the stretching amount of the pixel at the time point; and
based on the color sampling information, obtaining the color information of the pixel in the target image corresponding to the time point from the base image.

7. The method according to claim 6, wherein the color sampling information of the pixel which is any one of pixels in the target image at the time point is determined based on the location information of the reference observation point and the stretching amount of the pixel at the time point through following means:
determining a connecting line between the pixel and the reference observation point based on the location information of the reference observation point;
determining a target point on the connecting line, to make a difference value between a height corresponding to the target point and stretching amount corresponding to the target point be less than a preset difference value, wherein the height corresponding to the target point is a height of the target point relative to an image plane, and the stretching amount corresponding to the target point is stretching amount of a projected pixel of the target point on the image plane; and
determining location information corresponding to the projected pixel of the target point on the image plane as the color sampling information of the pixel.

8. The method according to claim 5, wherein generating the target images at the plurality of different time points according to the color information of the pixel at the plurality of different time points comprises:
using Gaussian blur algorithm to perform a blur rendering operation based on the color information of the pixel at the plurality of different time points to obtain the target images corresponding to the plurality of different time points.

9. A computer-readable storage medium, with a computer program stored thereon, wherein the computer program, when executed by a computer, enables the computer to implement a method for processing media, which comprises:
obtaining a base image, and determining luminance of a pixel in the base image;
determining visual stretching information based on the luminance of the pixel, wherein the visual stretching information comprises stretching amount of the pixel at a plurality of different time points, and at a same time point, stretching amount of the pixel is associated with the luminance of the pixel; and
based on the visual stretching information and the base image, obtaining a plurality of frames of target images for generating dynamic media.

10. The computer-readable storage medium according to claim 9, wherein obtaining the base image comprises:
obtaining a frame of an original image;
performing scaling processing on the original image according to a plurality of scaling ratios that are gradient to obtain a plurality of frames of base images, respectively.

11. The computer-readable storage medium according to claim 9, wherein determining the visual stretching information based on the luminance of the pixel comprises:
obtaining stretching coefficients respectively corresponding to the plurality of different time points; and
determining the visual stretching information according to products respectively obtained by multiplying the luminance and the stretching coefficients.

12. The computer-readable storage medium according to claim 11, wherein a stretching coefficient corresponding to a time point of the plurality of different time points is positively correlated with a cosine value of a time difference between the time point and a preset time point.

13. An electronic apparatus, comprising a memory and a processor, wherein the memory stores an executable code, and the processor, when executing the executable code, implements a method for processing media, which comprises:
obtaining a base image, and determining luminance of a pixel in the base image;
determining visual stretching information based on the luminance of the pixel, wherein the visual stretching information comprises stretching amount of the pixel at a plurality of different time points, and at a same time point, stretching amount of the pixel is associated with the luminance of the pixel; and
based on the visual stretching information and the base image, obtaining a plurality of frames of target images for generating dynamic media.

14. The electronic apparatus according to claim 13, wherein obtaining the base image comprises:
obtaining a frame of an original image;
performing scaling processing on the original image according to a plurality of scaling ratios that are gradient to obtain a plurality of frames of base images, respectively.

15. The electronic apparatus according to claim 13, wherein determining the visual stretching information based on the luminance of the pixel comprises:
obtaining stretching coefficients respectively corresponding to the plurality of different time points; and
determining the visual stretching information according to products respectively obtained by multiplying the luminance and the stretching coefficients.

16. The electronic apparatus according to claim 15, wherein a stretching coefficient corresponding to a time point of the plurality of different time points is positively correlated with a cosine value of a time difference between the time point and a preset time point.

17. The electronic apparatus according to claim 13, wherein based on the visual stretching information and the base image, obtaining the plurality of frames of target images for generating the dynamic media comprises:
obtaining location information of a reference observation point that is preset;
determining color information of the pixel in the target images at the plurality of different time points based on the location information of the reference observation point and the stretching amount of the pixel at the plurality of different time points; and
generating the target images at the plurality of different time points according to the color information of the pixel in the target images at the plurality of different time points.

18. The electronic apparatus according to claim 17, wherein, for a time point of the plurality of different time points, the color information of the pixel in a target image at the time point is determined based on the location information of the reference observation point and stretching amount of the pixel at the time point through following means:
determining color sampling information of the pixel in the target image at the time point based on the location information of the reference observation point and the stretching amount of the pixel at the time point; and
based on the color sampling information, obtaining the color information of the pixel in the target image corresponding to the time point from the base image.

19. The electronic apparatus according to claim 18, wherein the color sampling information of the pixel which is any one of pixels in the target image at the time point is determined based on the location information of the reference observation point and the stretching amount of the pixel at the time point through following means:
determining a connecting line between the pixel and the reference observation point based on the location information of the reference observation point;
determining a target point on the connecting line, to make a difference value between a height corresponding to the target point and stretching amount corresponding to the target point be less than a preset difference value, wherein the height corresponding to the target point is a height of the target point relative to an image plane, and the stretching amount corresponding to the target point is stretching amount of a projected pixel of the target point on the image plane; and
determining location information corresponding to the projected pixel of the target point on the image plane as the color sampling information of the pixel.

20. The electronic apparatus according to claim 17, wherein generating the target images at the plurality of different time points according to the color information of the pixel at the plurality of different time points comprises:
using Gaussian blur algorithm to perform a blur rendering operation based on the color information of the pixel at the plurality of different time points to obtain the target images corresponding to the plurality of different time points.
